(19) United States
(12) Patent Application Publication
(10) Pub. No.: US 2012/0292958 A1
(43) Pub. Date: Nov. 22, 2012

(54) MOTORCYCLE SEAT CUSHION

(75) Inventor: Anthony Eric Sprouse, II, O'Fallon, IL (US)

(73) Assignee: ROHO, INC., Belleville, IL (US)

(21) Appl. No.: 13/309,767

(22) Filed: Dec. 2, 2011

Related U.S. Application Data
(60) Provisional application No. 61/487,036, filed on May 17, 2011.

(51) Int. Cl. B62J 1/26; B60N 2/56; B62J 1/22

(52) U.S. Cl. 297/200; 297/214; 297/452.41

(57) ABSTRACT

A motorcycle seat cushion comprising a base with an array of upstanding air cells across the base. In one aspect, the air cells are interconnected such that pressure is spread cross a wider area to reduce pressure points. There are external air flow pathways between the cells that allow air to circulate among the cells to disperse heat and moisture. There is a midline pathway that is positioned under the perineum and coccyx of the rider to provide pressure relief to the perineum, prostate and coccyx of the male rider. In one aspect, the cushion includes a cover having top and side walls of the cover constructed from a two-way stretch material. The cover has air vents that functionally align with at least some of the air flow pathways to promote the flow of ambient air into the air flow pathways.

### CROSS REFERENCE TO RELATED APPLICATIONS

This application claims the benefit of provisional application Ser. No. 61/487,036, filed May 17, 2011, which is incorporated herein by reference.

### STATEMENT REGARDING FEDERALLY SPONSORED RESEARCH OR DEVELOPMENT

Not Applicable.

### BACKGROUND OF THE INVENTION

The application relates generally to vehicle seating and, more specifically to a motorcycle seat cushion that relieves pressure on various points of the rider's anatomy and improves ventilation at the interface between the rider and the cushion.

Motorcycle seats or saddles are well known. In general, a motorcycle seat is constructed to support the seated rider's buttocks and, depending upon the size and style, a portion of the upper thigh. Most motorcycle seats or saddles are constructed from firm support padding or foam with a leather or vinyl covering. In use the rider straddles the seat, thereby exposing the inner thigh, buttocks and genital area to pressure and vibration. Also, in warm weather there can be a buildup of moisture or heat which could, over long periods of time, lead to skin breakdown. If the rider is seated for long periods of time he can develop discomfort, soreness and even numbness in these regions of the anatomy due to pressure and vibration on the nerves. Furthermore, riders of other vehicles, such as bicycles, motor scooters and the like can suffer from similar discomforts.

It would be advantageous, therefore, to have a seat cushion that provides support while relieving pressure on sensitive areas of the anatomy and reducing heat and moisture buildup.

### SUMMARY OF THE INVENTION

In one aspect, a motorcycle seat cushion comprising a base, with an array of upstanding cells across the base. In one aspect, the cells are inflatable air cells that are interconnected such that pressure is spread cross a wider area to reduce pressure points. There are air flow pathways between the cells that allow air to circulate among the cells to disperse heat and moisture. There is a midline pathway that is positioned under the perineum of the rider to provide pressure relief to the perineum and prostate of the male rider. The midline pathway also provides relief to the coccyx of the seated rider.

In one aspect, the cushion includes a cover. In one aspect, at least the top and side walls of the cover are constructed from a material having two-way stretch characteristics. Also, the cover has openings or air vents that align with at least some of the air flow pathways to promote the flow of ambient air into the air flow pathways, particularly as the motorcycle is moving.

In one aspect the cushion can be employed with any vehicle, motorized or self-propelled, such as motorcycles, scooters bicycles, personal water craft or the like.

In one aspect, the cushion is fabricated from a dip molded neoprene to enhance the support characteristics. In other aspects, the cushion could be vacuum molded from a thermoplastic material as well.

### BRIEF DESCRIPTION OF THE DRAWINGS

FIG. 1 is a top plan view of one aspect of the cushion;

FIG. 2 is a bottom plan view thereof;

FIG. 3 is front elevational view thereof;

FIG. 4 is a rear elevational view thereof;

FIG. 5 is a right side elevational view thereof;

FIG. 6 is a left side elevational view thereof; and

FIG. 7 is a top plan view of the cushion and cover combination.

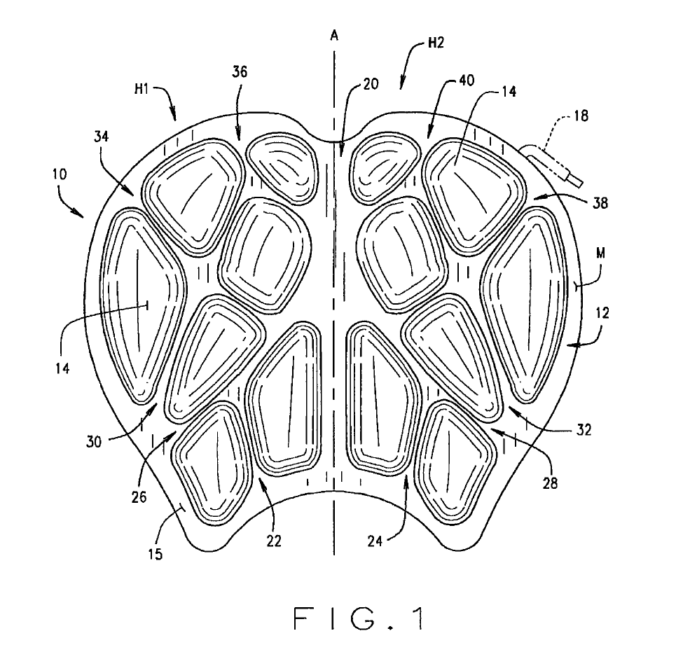

### DETAILED DESCRIPTION

One aspect of a motorcycle cushion is indicated generally by reference number 10 in the drawings. Although referred to as a motorcycle cushion for brevity and clarity, it will be appreciate the cushion can be employed with any seat, particularly, but not limited to, seats on vehicles, either self-propelled or motorized.

Cushion 10 includes a base 12 with a plurality of upstanding air inflation cells 14 arranged in an array on the base. In one aspect, cells 14 are inflatable air cells and are generally hollow open-bottomed cells connected by web 15 which comprises the top layer of base 12. In one aspect, the web and cell arrangement are dip molded from neoprene, as disclosed in U.S. Pat. No. 4,451,136, which is incorporated herein by reference. However, the web and cell arrangement may be formed in any acceptable manner from any acceptable material, such as cavity molded or dip molded plastic material or the like.

One skilled in the art will recognize that other types of upstanding cells, such as foam or gel filled cells, are within the scope of the invention. Moreover, the cells can be combinations of different cells, such as combinations of inflatable air cells, foam cells or gel filled cells as desired for modification of the support characteristics of the cushion.

In the illustrated aspect of the cushion, base 12 has a perimeter configuration or margin M that is substantially similar to the outline of buttocks of a seated motorcycle rider. The array of cells is symmetrical and divided by a center axis A into two halves H1 and H2. The array of cells in H1 is a mirror image of the array of cells in H2. It will be noted that cells 14 comprising each half are arranged so that there is substantially contiguous air cell support under each buttock of the rider. Hence, in the illustrated aspect of the cushion, each half includes seven (7) cells, each of the cells in a half has a different configuration, yet the cells in a half are complementary to each other so as to provide optimum support area under a buttock of a seated rider. Although the illustrated embodiment employs seven different cells in each half, it is within the scope of the invention to use any number of cells having any configurations that cooperate to form an acceptable support surface.

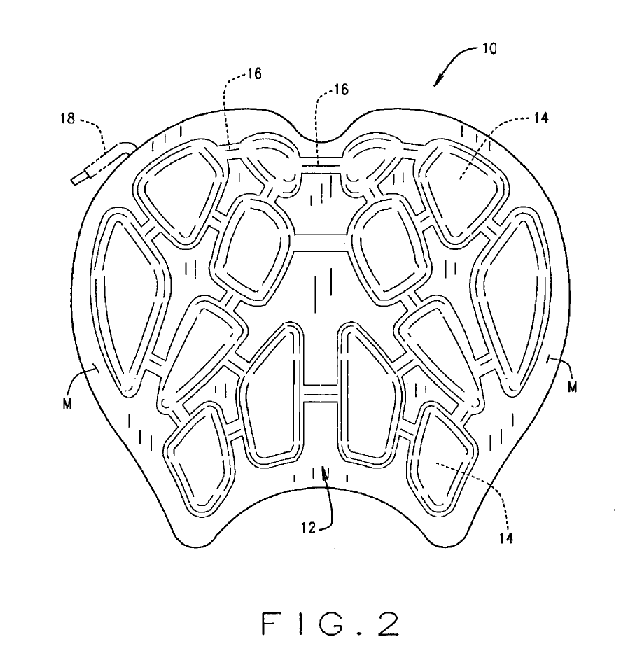

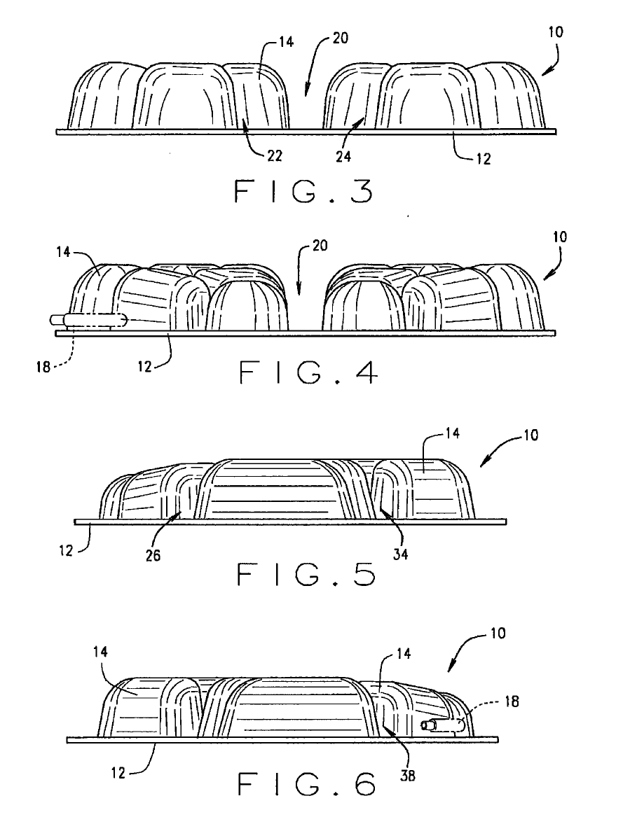

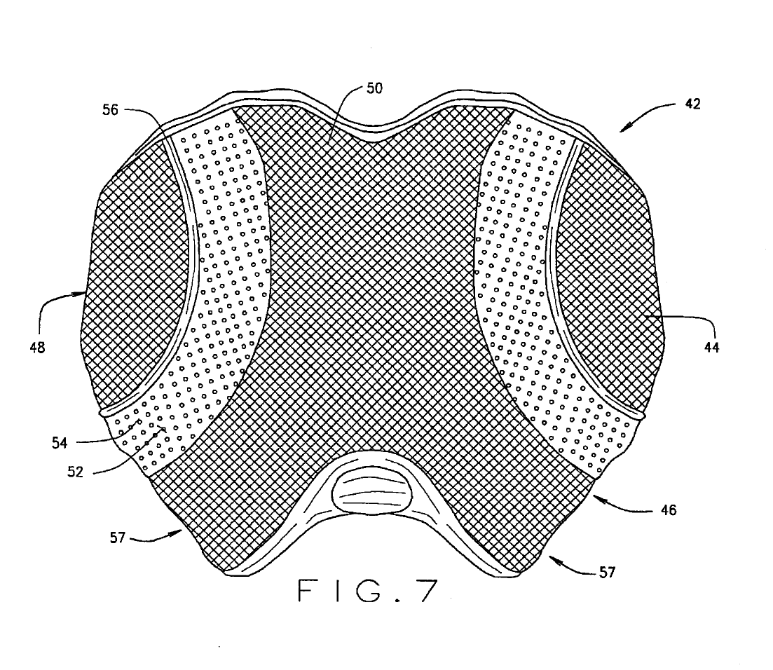

Referring to FIG. 2, it can be seen that all cells 14 are interconnected by a plurality of fluid flow channels 16. The fluid flow channels extend through base 12 to place interconnected cells in fluid communication. There is an inflation valve 18 in fluid communication with at least one of the cells. Since the cells are interconnected, all of the cells can be inflated by introducing air through valve 18. Any suitable air pump may be used. In one aspect, a bulb pump is affixed to inflation valve 18 so that cushion 10 can be inflated or adjusted as desired while positioned on a motorcycle. Any other inflation device may be used, for example, an external pump or a powered pump associated with the cushion or with the motorcycle.

Because cells 14 are interconnected by fluid flow channels 16, internal pressure is equalized among all the inflated cells when a rider sits on an inflated cushion so as to spread the restoring force over a greater area. Furthermore, as the rider shifts position, the cushion will adjust to the user's anatomy. Hence, the design reduces pressure in discrete areas of the anatomy. The cushion provides a more comfortable ride while reducing pressure.

In another aspect, the different sizes or diameters of fluid flow channels 16 can be employed to customize or control the air flow among interconnected air cells thereby adjusting or controlling the support characteristics of the air cells under load. Also, groups of air cells can be isolated from other groups of air cells to create inflation zones with desired support characteristics.

In another aspect, the air cells can be pre-inflated to an optimum level and sealed to maintain that level without pumping or adjustment.

Referring to drawings it will be appreciated that the cells in the two halves are spaced apart at center axis A creating a center air flow path 20 between the two groups of cells. Furthermore, center air flow path 20 creates a void so as to relieve pressure on the perineum and genital area of the seated rider, provide relief from nerve compression in that area, and relieve pressure on the prostate of the male rider.

Moreover, air flow path 20 extends the length of the seat cushion so as to be positioned at the approximate mid-point of the buttocks providing relief to the coccyx of the seated rider.

There is a pair of forward air flow pathways 22, 24 extending between cells from the left and right forward margin areas of the cushion, respectively. There are intermediate air flow pathways 26, 28 that extend from the left and right forward margins, respectively, to center air flow path 20. Moreover, long flow pathways 30, 32 extending between cells from near the middle of the forward side margin areas toward the rear of cushion 10. There are transecting air flow pathways 34, 36 between cells on half H1 and transecting air flow pathways, 38 and 40 that extend between cells in the half H2. The transecting air flow pathways extend from the rear margins generally perpendicularly toward the middle and long air flow pathways. It will be appreciated that there are air flow pathways around each cell 14 that extend inwardly from the outer edge or margin of the cushion.

Although the illustrated air flow pathways work well for the intended purposes, it will be understood that the positioning, arrangement and number of air flow pathways between and among the cells may vary without departing from the scope of the appended claims.

FIG. 7 shows cushion 10 within a cover 42. Cover 42 has a peripheral configuration complementary to the configuration of the cushion. Cover 42 has a top 44 and a bottom 46 connected by a circumferential side wall 48. Top 44 comprises a stretchy mesh material having ventilation holes 50. It also includes a contrasting material 52, such as leather, vinyl or tight weave cloth at the buttock areas. This contrasting material generally defines a plurality of perforations or air holes 54. The top also can include a decorative piping 56. The contrasting material and piping generally are positioned at high wear areas of the cover top. Bottom wall 46 can be a solid or mesh material or, in one aspect, a material having a high coefficient of friction such as rubberized mesh or weave to keep the seat cushion from slipping when placed on a motorcycle. The cushion cover also may employ straps, hook and loop fastener, or other attachment apparatus to secure the cushion to the motorcycle seat.

Circumferential wall 48 can be a perforated or mesh fabric material. However, in a preferred aspect, wall 48 has vent areas 57 adjacent the forward ends of the air flow pathways to allow ingress of air through the cover and into the air flow pathways between the cells to ventilate the cushion. The vent areas may be positioned anywhere on the seat cover such that they are in functional alignment with the air cells. That is, the vents allow air into the cover to circulate among the air cells. This ventilation system helps cool the rider's buttocks and crotch and dry perspiration and other moisture.

It will be appreciated that various changes and modification may be made in the motorcycle seat cushion of the present invention without departing from the scope of the invention. By way of example only, the cushion can have different configurations and be constructed in varying sizes so as to fit on different types of motorcycle saddles. The cushion and the cover can be constructed of different materials as well. The embodiment shown and described is intended to be illustrative of the broader aspects of the invention and should not be construed in a limiting sense.

1. A motorcycle seat cushion comprising:
a base having an array of discrete upstanding cells on the base, said cells defining a plurality of air flow pathways between the cells that allow air to circulate among the cells to disperse heat and moisture, with one of said pathways being a midline pathway positioned under a perineal and coccyx area of a seated rider to provide pressure relief to the perineum and coccyx.

2. The motorcycle seat cushion of claim 1 further comprising a cover over the cushion.

3. The motorcycle sear cushion of claim 2 wherein said cover defines at least one vent area to allow air flow to at least one air flow pathway defined by the cells.

4. The motorcycle seat cushion of claim 1 wherein at least some of the array of upstanding air cells are inflatable air cells.

5. The motorcycle seat cushion of claim 1 wherein at least some of the array of upstanding air cells are in fluid communication with each other through the base such that inflation pressure is equalized among the interconnected cells.

6. The motorcycle seat cushion of claim 1 wherein at least some of the array of upstanding cells are foam cells.

7. The motorcycle seat cushion of claim 1 wherein at least some of the array of upstanding cells are gel filled cells.

8. A seat cushion comprising:
a base;
an array of upstanding air cells on the base, said air cells spaced apart and defining a plurality pathways between the cells; and
a cover over the array of air cells.

9. The seat cushion of claim 8 wherein the air cells are interconnected through the base.

10. The seat cushion of claim 8 wherein the cover defines at least one vent in functional alignment with the air cells.

11. The seat cushion of claim 8 wherein the base and air cells are formed from neoprene.

12. A vehicle seat cushion comprising:
a base having a peripheral configuration substantially conforming to the peripheral configurations of buttocks of a seated person;
an array of interconnected, upstanding air cells on the base, said air cells spaced apart and defining a plurality pathways between the cells; and
a cover over the array of air cells, the cover having at least one ventilation area in functional alignment with the array of upstanding air cells.

13. The vehicle seat cushion of claim 12 wherein the cells define a pathway along a midline of the cushion with an equal number of cells on a first side of the midline and an equal number of cells on a second side of the midline.

14. The vehicle seat cushion of claim 13 wherein the cells on the first side of the midline are a mirror image of the cells on the second side of the midline.
